(19) United States
(12) Patent Application Publication
(10) Pub. No.: US 2013/0179186 A1
(43) Pub. Date: Jul. 11, 2013

(54) SYSTEM AND METHOD FOR DATABASE SYNCHRONIZATION FOR MEDICAL RECORDS

(71) Applicants: Daniel P. Birtwhistle, Fishers, IN (US); Matthew Burke, Westfield, IN (US); Allen B. Cummings, Westfield, IN (US); Jonathon Fuller, Carmel, IN (US); Igor Gejdos, Indianapolis, IN (US); Jochen Kohler, Walldorf (DE); Tobias Glöckner, Walldorf (DE); Morris J. Young, Noblesville, IN (US)

(72) Inventors: Daniel P. Birtwhistle, Fishers, IN (US); Matthew Burke, Westfield, IN (US); Allen B. Cummings, Westfield, IN (US); Jonathon Fuller, Carmel, IN (US); Igor Gejdos, Indianapolis, IN (US); Jochen Kohler, Walldorf (DE); Tobias Glöckner, Walldorf (DE); Morris J. Young, Noblesville, IN (US)

(73) Assignee: Roche Diagnostics Operations, Inc., Indianapolis, IN (US)

(21) Appl. No.: 13/348,127

(22) Filed: Jan. 11, 2012

(51) Int. Cl. G06Q 50/24

(52) U.S. Cl. 705/3

(57) ABSTRACT

A system and method for performing database synchronization between a first database of a first device and a second database of a second device is disclosed. The first database stores medical records having non-time based counter values associated thereto. The second database stores medical records having timestamps associated thereto. The first device includes a first database synchronization module that maintains a last timestamp indicating a last medical record that was received from the second device. The first database synchronization module transmits, to the second device, a request for synchronization and the last timestamp. The second device includes a second database synchronization module that maintains a last counter value indicative of a last medical record that was received from the first device, and that transmits, to the first device, a second request for synchronization and the last counter value.

### FIELD

The present disclosure relates to a system and method for synchronizing databases storing medical records.

### BACKGROUND

Medical devices are often used as diagnostic devices and/or therapeutic devices in diagnosing and/or treating medical conditions of patients. For example, a blood glucose meter is used as a diagnostic device to measure blood glucose levels of patients suffering from diabetes. An insulin infusion pump is used as a therapeutic device to administer insulin to patients suffering from diabetes.

Diabetes mellitus, often referred to as diabetes, is a chronic condition in which a person has elevated blood glucose levels that result from defects in the body's ability to produce and/or use insulin. There are three main types of diabetes. Type 1 diabetes may be autoimmune, genetic, and/or environmental and usually strikes children and young adults. Type 2 diabetes accounts for 90-95% of diabetes cases and is linked to obesity and physical inactivity. Gestational diabetes is a form of glucose intolerance diagnosed during pregnancy and usually resolves spontaneously after delivery.

In 2009, according to the World Health Organization, at least 220 million people worldwide suffer from diabetes. In 2005, an estimated 1.1 million people died from diabetes. The incidence of diabetes is increasing rapidly, and it is estimated that between 2005 and 2030, the number of deaths from diabetes will double. In the United States, nearly 24 million Americans have diabetes, and an estimated 25% of seniors age 60 and older are affected. The Centers for Disease Control and Prevention forecast that 1 in 3 Americans born after 2000 will develop diabetes during their lifetime. The National Diabetes Information Clearinghouse estimates that diabetes costs $132 billion in the United States alone every year. Without treatment, diabetes can lead to severe complications such as heart disease, stroke, blindness, kidney failure, amputations, and death related to pneumonia and flu.

Diabetes is managed primarily by controlling the level of glucose in the bloodstream. This level is dynamic and complex, and is affected by multiple factors including the amount and type of food consumed, and the amount of insulin (which mediates transport of glucose across cell membranes) in the blood. Blood glucose levels are also sensitive to exercise, sleep, stress, smoking, travel, illness, menses, and other psychological and lifestyle factors unique to individual patients. The dynamic nature of blood glucose and insulin and all other factors affecting blood glucose often require a person with diabetes to forecast blood glucose levels. Therefore, therapy in the form of insulin, oral medications, or both can be timed to maintain blood glucose levels in an appropriate range.

Management of diabetes is time-consuming for patients because of the need to consistently obtain reliable diagnostic information, follow prescribed therapy, and manage lifestyle on a daily basis. Diagnostic information such as blood glucose is typically obtained from a capillary blood sample with a lancing device and is then measured with a handheld blood glucose meter. Interstitial glucose levels may be obtained from a continuous glucose sensor worn on the body. Prescribed therapies may include insulin, oral medications, or both. Insulin can be delivered with a syringe, an ambulatory infusion pump, or a combination of both. With insulin therapy, determining the amount of insulin to be injected can require forecasting meal composition of fat, carbohydrates, and proteins along with effects of exercise or other physiological states. The management of lifestyle factors such as body weight, diet, and exercise can significantly influence the type and effectiveness of therapy.

Management of diabetes involves large amounts of diagnostic data and prescriptive data acquired in a variety of ways: from medical devices, from personal healthcare devices, from patient-recorded logs, from laboratory tests, and from healthcare professional recommendations. Medical devices include patient-owned bG meters, continuous glucose monitors, ambulatory insulin infusion pumps, diabetes analysis software. Each of these systems generates and/or manages large amounts of diagnostic and prescriptive data. Personal healthcare devices include weight scales, blood pressure cuffs, exercise machines, thermometers, and weight management software. Patient recorded logs include information relating to meals, exercise, and lifestyle. Lab test results include HbAlC, cholesterol, triglycerides, and glucose tolerance. Healthcare professional recommendations include prescriptions, diets, test plans, and other information relating to the treatment of the patient.

There is a need for a system to efficiently handle medical records such as diagnostic and prescriptive data. Furthermore, there is a need to be able to reliably aggregate, manipulate, manage, present, and communicate diagnostic data and prescriptive data from medical devices, personal healthcare devices, patient recorded information, biomarker information, and recorded information in an efficient manner and at multiple devices without sacrificing data integrity. There is a technical issue that arises when medical data records are exchanged between devices, as more current data may be overwritten by older data records during synchronization.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

In a first aspect of the disclosure, a data synchronization system for synchronizing medical records between a first device and a second device is disclosed. The system comprises a first database at the first device that stores a plurality of first medical records. Each first medical record has a counter value associated thereto. The counter value is indicative of when a first database operation was performed thereon in relation to when other first database operations were performed on other first medical records of the plurality of first medical records. The system further comprises a second database at the second device that stores a plurality of second medical records. Each second medical record has a timestamp associated thereto. The timestamp is indicative of a time when a second database operation was performed on the second medical record. The system also includes a first database synchronization module associated with the first device that maintains a last timestamp indicative of a last second medical record of the plurality of second medical records that was most recently received by the first device from the second device, and that transmits, to the second device, a first request for synchronization of the first database with the second database and the last timestamp. The system further comprises a second database synchronization module associated with the second device that maintains a last counter value indicative of a last first medical record of the plurality of first medical records that was most recently received by the second device from the first device, and that transmits, to the first device, a second request for synchronization of the second database with the first database and the last counter value.

In another aspect of the disclosure, a data synchronization method for synchronizing medical records between a first device and a second device is disclosed. The method comprises storing, at the first device, a plurality of first medical records on a first database. Each first medical record has a counter value associated thereto. The counter value is indicative of when a first database operation was performed thereon in relation to when other first database operations were performed on other first medical records of the plurality of first medical records. The method further comprises storing, at the second device, a plurality of second medical records on a second database. Each second medical record has a timestamp associated thereto, the timestamp being indicative of a time when a second database operation was performed on the second medical record. The method further comprises maintaining, at the first device, a last timestamp indicative of a last second medical record of the plurality of second medical records that was most recently received by the first device from the second device, and transmitting, from the first device to the second device, a first request for synchronization of the first database with the second database and the last timestamp. The method further comprises maintaining, at the second device, a last counter value indicative of a last first medical record of the plurality of first data records which was most recently received by the second device from the first device, and transmitting, from the second device to the first device, a second request for synchronization of the second database with the first database and the last counter value.

This section provides a general summary of the disclosure, and is not a comprehensive disclosure of its full scope or all of its features. Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

FIG. 1 shows a patient and a treating clinician;

FIG. 2 shows a patient with a continuous glucose monitor (CGM), ambulatory durable insulin infusion pump, ambulatory non-durable insulin infusion pump, and diabetes manager;

FIG. 3 shows a diabetes care system of systems used by patients and clinicians to manage diabetes;

FIG. 4 shows an environment for performing database synchronization according to some embodiments of the present disclosure;

FIG. 5 shows a block diagram illustrating a system for performing database synchronization according to some embodiments of the present disclosure;

FIG. 6 shows a flow chart illustrating a method for requesting database synchronization according to some embodiments of the present disclosure;

FIG. 7 shows a flow chart illustrating a method for requesting database synchronization according to some embodiments of the present disclosure;

FIG. 8 shows a flow chart illustrating a method for responding to a request for database synchronization according to some embodiments of the present disclosure;

FIG. 9 shows a flow chart illustrating a method for responding to a request for database synchronization according to some embodiments of the present disclosure;

FIG. 10 shows an example of a unique identifier of a medical record according to some embodiments of the present disclosure; and

FIGS. 11A and 11B show an example of a two-way database synchronization according to some embodiments of the present disclosure.

Corresponding reference numerals indicate corresponding parts throughout the several views of the drawings. The drawings described herein are for illustrative purposes only of selected embodiments and not all possible implementations, and are not intended to limit the scope of the present disclosure.

### DETAILED DESCRIPTION

Example embodiments will now be described more fully with reference to the accompanying drawings.

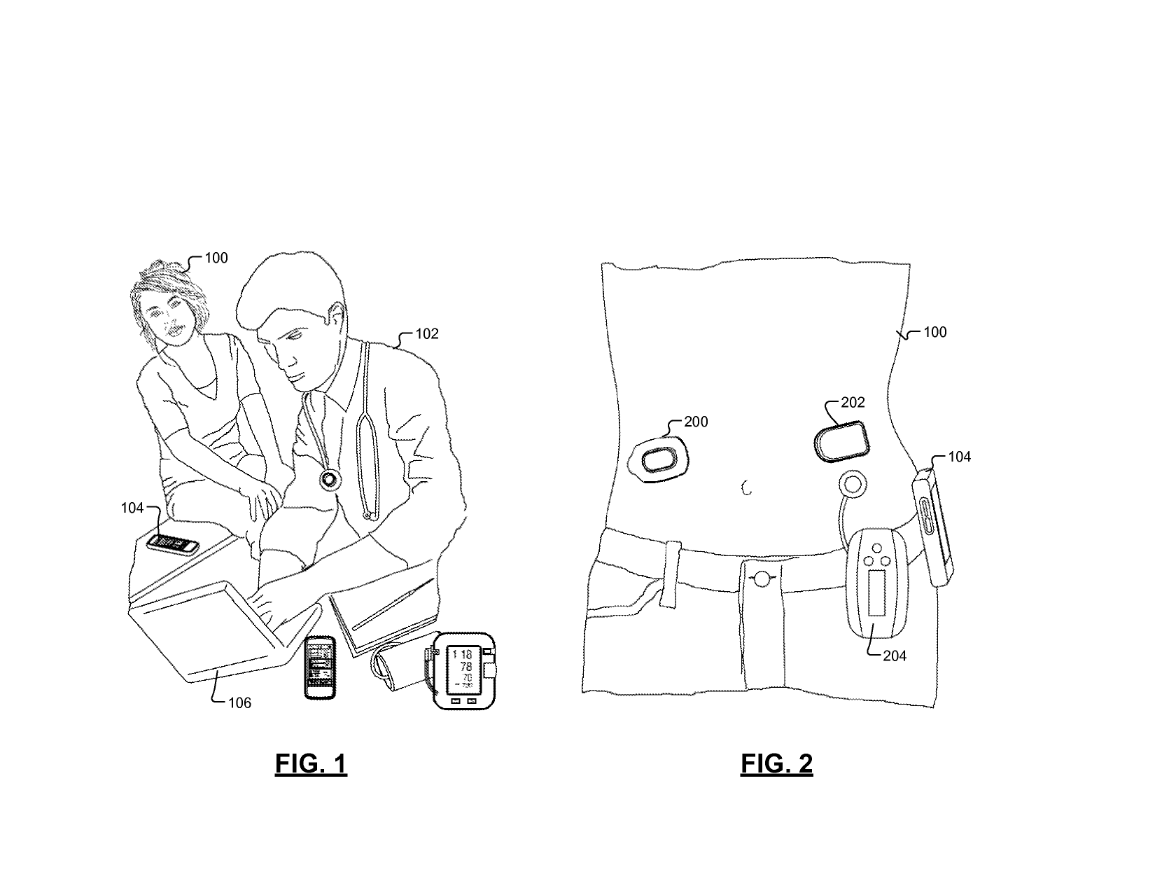

Referring now to FIG. 1, a person 100 with diabetes and a healthcare professional 102 are shown in a clinical environment. Persons with diabetes include persons with metabolic syndrome, pre-diabetes, type 1 diabetics, type 2 diabetics, and gestational diabetics and are collectively referred to as a patient. Healthcare providers for diabetes are diverse and include nurses, nurse practitioners, physicians, and endocrinologists and are collectively referred to as a clinician.

During a healthcare consultation, the patient 100 typically shares with the clinician 102 a variety of patient data including blood glucose measurements, continuous glucose monitor data, amounts of insulin infused, amounts of food and beverages consumed, exercise schedules, and other lifestyle information. The clinician 102 may obtain additional patient data that includes measurements of HbAlC, cholesterol levels, triglycerides, blood pressure, and weight of the patient 100. The patient data can be recorded manually or electronically on a handheld diabetes management device 104, a diabetes analysis software executed on a personal computer (PC) 106, and/or a web-based diabetes analysis site (not shown). The clinician 102 can analyze the patient data manually or electronically using the diabetes analysis software and/or the web-based diabetes analysis site. After analyzing the patient data and reviewing adherence of the patient 100 to previously prescribed therapy, the clinician 102 can decide whether to modify the therapy for the patient 100.

Referring now to FIG. 2, the patient 100 can use a continuous glucose monitor (CGM) 200, an ambulatory durable insulin infusion pump 202 or an ambulatory non-durable insulin infusion pump 204 (collectively insulin pump 202 or 204), and the handheld diabetes management device 104 (hereinafter the diabetes manager 104). The CGM 200 uses a subcutaneous sensor to sense and monitor the amount of glucose in the blood of the patient 100 and communicates corresponding readings to the handheld diabetes management device 104.

The diabetes manager 104 performs various tasks including measuring and recording blood glucose levels, determining an amount of insulin to be administered to the patient 100 via the insulin pump 202 or 204, receiving patient data via a user interface, archiving the patient data, etc. The diabetes manager 104 periodically receives readings from the CGM 200 indicating insulin level in the blood of the patient 100. The diabetes manager 104 transmits instructions to the insulin pump 202 or 204, which delivers insulin to the patient 100. Insulin can be delivered in the form of a bolus dose, which raises the amount of insulin in the blood of the patient 100 by a predetermined amount. Additionally, insulin can be delivered in a scheduled manner in the form of a basal dose, which maintains a predetermined insulin level in the blood of the patient 100.

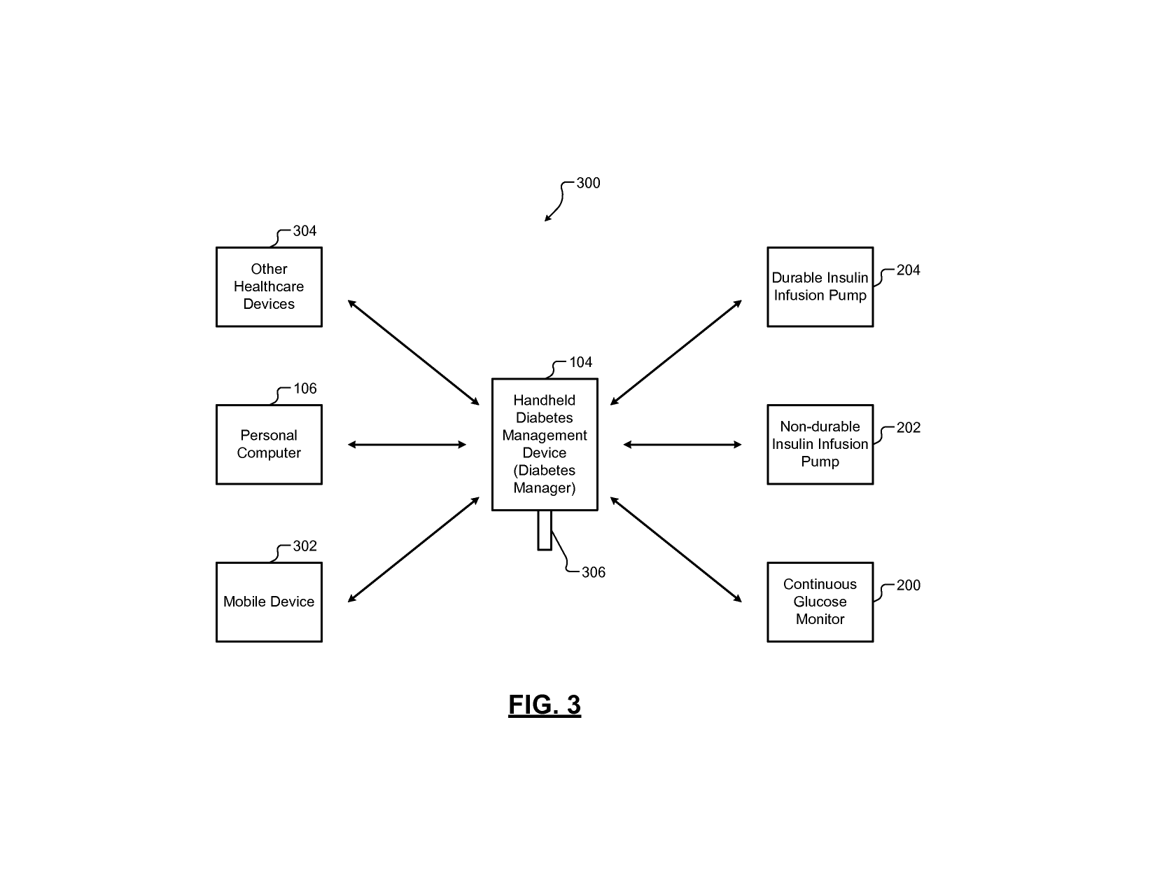

Referring now to FIG. 3, a diabetes management system 300 used by the patient 100 and the clinician 102 includes one or more of the following devices: the diabetes manager 104, the continuous glucose monitor (CGM) 200, the insulin pump 202 or 204, a mobile device 302, the diabetes analysis software on the PC 106, and other healthcare devices 304. The diabetes manager 104 is configured as a system hub and communicates with the devices of the diabetes management system 300. Alternatively, the insulin pump 204 or the mobile device 302 can serve as the system hub. Communication between the various devices in the diabetes management system 300 can be performed using wireless interfaces (e.g., Bluetooth) and/or wireline interfaces (e.g., USB). Communication protocols used by these devices can include protocols compliant with the IEEE 11073 standard as extended using guidelines provided by Continua® Health Alliance Design Guidelines. Further, healthcare records systems such as Microsoft® HealthVault™ can be used by the patient 100 and clinician 102 to exchange information.

The diabetes manager 104 can receive blood glucose readings from one or more sources (e.g., from the CGM 200). The CGM 200 continuously measures the blood glucose level of the patient 100. The CGM 200 periodically communicates the blood glucose level to the diabetes manager 104. The diabetes manager 104 and the CGM 200 communicate wirelessly using a proprietary Gazell wireless protocol developed by Nordic Semiconductor, Inc.

Additionally, the diabetes manager 104 includes a blood glucose meter (BGM) and a port that communicates with the BGM (both not shown). The port can receive a blood glucose measurement strip 306. The patient 100 deposits a sample of blood or other bodily fluid on the blood glucose measurement strip 306. The BGM analyzes the sample and measures the blood glucose level in the sample. The blood glucose level measured from the sample and/or the blood glucose level read by the CGM 200 can be used to determine the amount of insulin to be administered to the patient 100.

The diabetes manager 104 communicates with the insulin pump 202 or 204. The insulin pump 202 or 204 can be configured to receive instructions from the diabetes manager 104 to deliver a predetermined amount of insulin to the patient 100. Additionally, the insulin pump 202 or 204 can receive other information including meal and/or exercise schedules of the patient 100. The insulin pump 202 or 204 can determine the amount of insulin to administer based on the additional information.

The insulin pump 202 or 204 can also communicate data to the diabetes manager 104. The data can include amounts of insulin delivered to the patient 100, corresponding times of delivery, and pump status. The diabetes manager 104 and the insulin pump 202 or 204 can communicate using a wireless communication protocol such as Bluetooth. Other wireless or wireline communication protocols can also be used.

In addition, the diabetes manager 104 can communicate with other healthcare devices 304. For example, the other healthcare devices 304 can include a blood pressure meter, a weight scale, a pedometer, a fingertip pulse oximeter, a thermometer, etc. The other healthcare devices 304 obtain and communicate personal health information of the patient 100 to the diabetes manager 104 through wireless, USB, or other interfaces. The other healthcare devices 304 use communication protocols compliant with ISO/IEEE 11073 extended using guidelines from Continua® Health Alliance. The diabetes manager 104 can communicate with the other healthcare devices 304 using interfaces including Bluetooth, USB, etc. Further, the devices of the diabetes management system 300 can communicate with each other via the diabetes manager 104.

The diabetes manager 104 can communicate with the PC 106 using Bluetooth, USB, or other interfaces. A diabetes management software running on the PC 106 includes an analyzer-configurator that stores configuration information of the devices of the diabetes management system 300. The configurator has a database to store configuration information of the diabetes manager 104 and the other devices. The configurator can communicate with users through standard web or computer screens in non-web applications. The configurator transmits user-approved configurations to the devices of the diabetes management system 300. The analyzer retrieves data from the diabetes manager 104, stores the data in a database, and outputs analysis results through standard web pages or computer screens in non-web based applications.

The diabetes manager 104 can communicate with the mobile device 302 using Bluetooth. The mobile device 302 may include a cellular phone, a PDA, or a pager. The diabetes manager 104 can send messages to an external network through the mobile device 302. The mobile device 302 can transmit messages to the external network based on requests received from the diabetes manager 104.

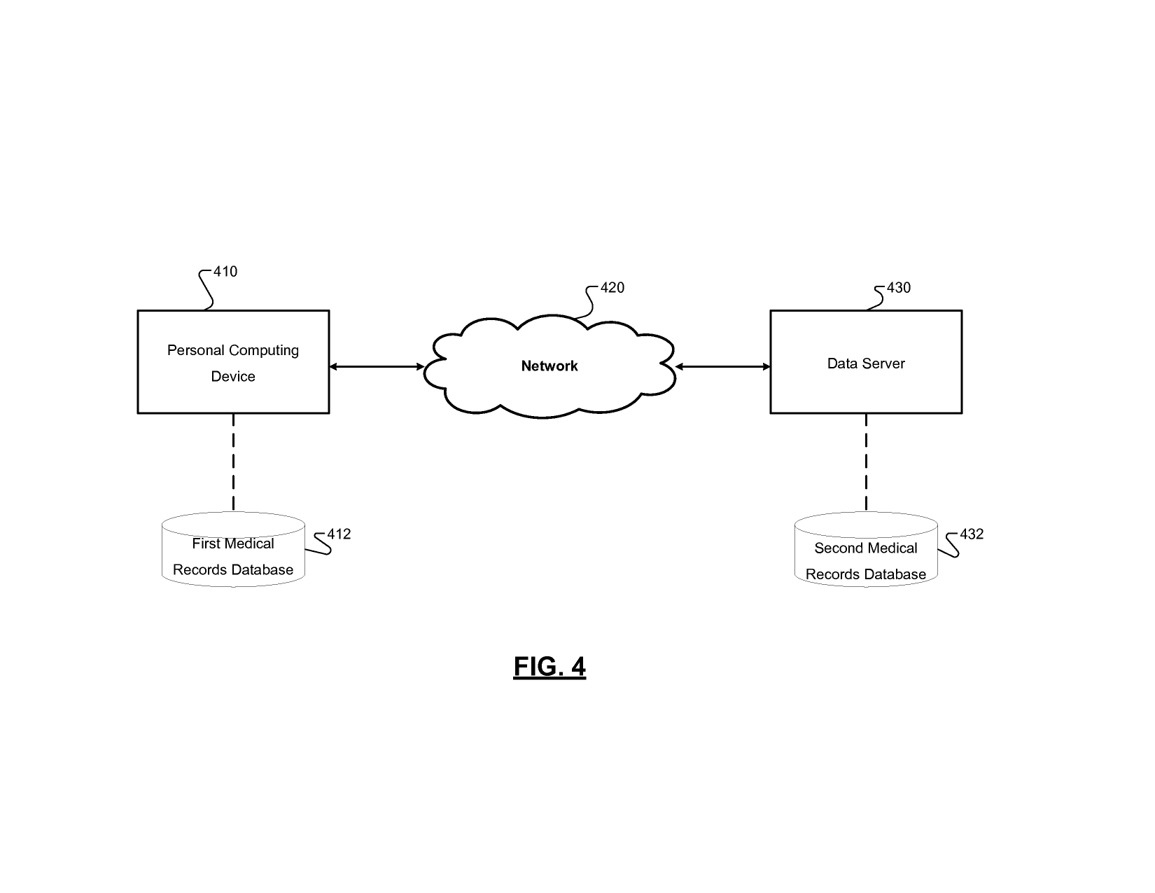

Referring now to FIG. 4, an environment 400 for managing medical records of one or more patients is shown. While patient data corresponding to the treatment of diabetes is described above, the patient described above can relate to any type of patient data. For example, the patient data may relate to the treatment of heart disease, cancer, obesity, diabetes, or any other condition. The patient data can be stored on one or more devices in the form of medical records. A patient or a treating physician thereof can utilize a personal computing device 410 to store a first plurality of medical records corresponding to the patient in a first medical records database 412, herein referred to the first database 412. The environment 400 further includes a data server 430 which stores a second of plurality of medical records corresponding to the patient in a second medical records database 432, herein referred to as the second database 432. It should be appreciated that the data server 430 may include medical records of other patients in addition to the medical records of the patient. Medical records of the patient can be synchronized between the personal computing device 410 and the data server 430 over a network 420, such as the Internet or an intranet. While a personal computing device 410 and data server 430 are described, the first database 412 and the second database 432 may be implemented on other types of devices. For instance, in the setting of treating a patient with diabetes, one of the first database 412 and the second database 432 may be implemented on a diabetes management device 104 (FIGS. 2 and 3).

Synchronization can be a process of establishing consistency between the first database 412 and the second database 432. The act of synchronizing the first database 412 and the second database 432 can include pairing the personal computing device 410 and the data server 430 so that the first plurality of medical records mirrors the second plurality of medical records. Thus, if a new medical record is written to the first database 412, upon synchronization, the new medical record is written to the second database 432. Similarly, when a medical record is modified on the second database 432, the modified medical record is updated on the first database 412 upon synchronization of the first database 412 and the second database 432.

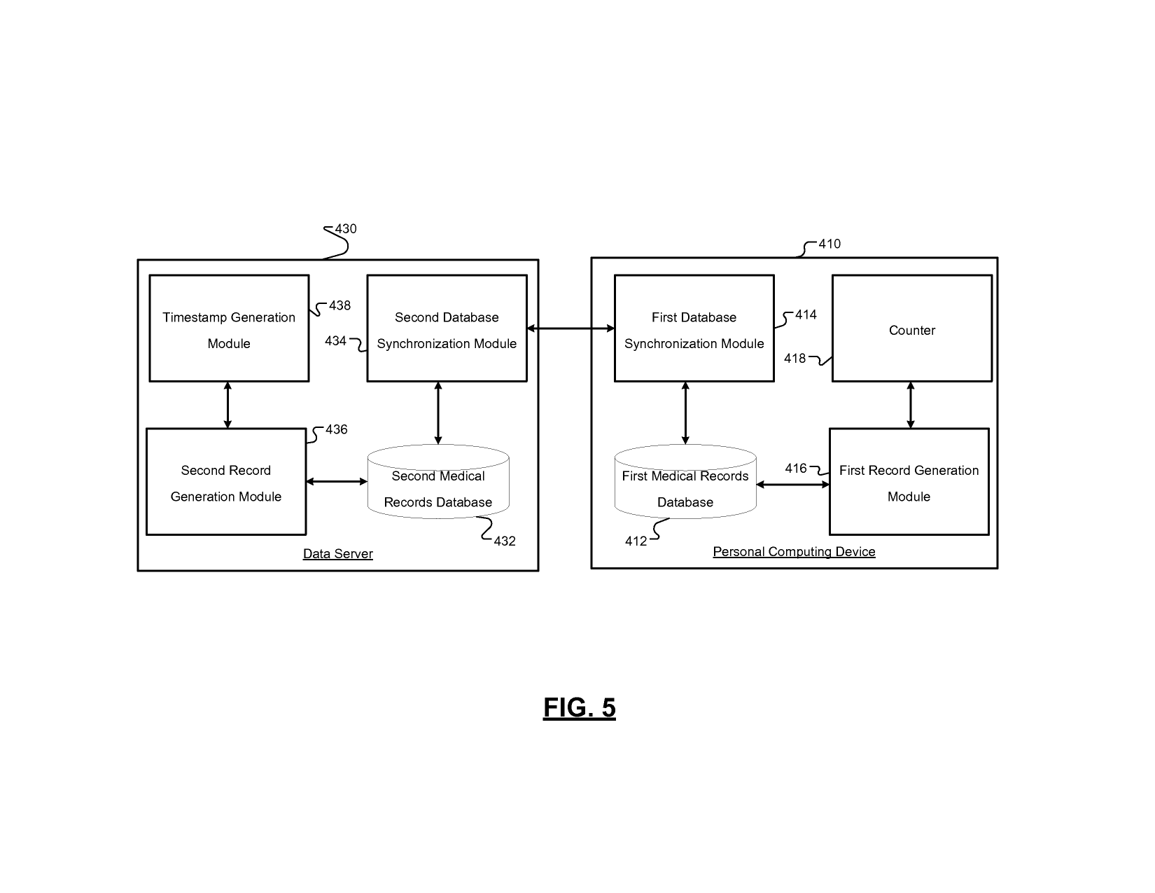

One issue that may arise is that the personal computing device 410 and the data server 430 may not have knowledge of what medical records were recently added to or modified on the other device. FIG. 5 illustrates an example system for performing database synchronization of medical records. In the illustrated example, the personal computing device 410 is in communication with data server 430. The personal computing device 410 can include the first database 412, a first database synchronization module 414, a first record generation module 416, and a counter 418. The data server 430 can include the second database 432, a second database synchronization module 434, a second record generation module 436, and a timestamp generation module 438.

As discussed, the first database 412 stores a first plurality of medical records. The medical records can be received from a wide variety of sources. For example, in the setting of diabetes treatment, the personal computing device 410 may receive data from one or more of the diabetes manager 104 (FIG. 3), the continuous glucose monitor (CGM) 200 (FIG. 3), the insulin pump 202 or 204 (FIG. 3), a mobile device 302 (FIG. 3), and a user interface (not shown) of the personal computing device 410. The received data can be stored as medical records in the first database 412. Furthermore, the first database 412 may receive medical records from the second database 432 by way of a database synchronization.

The first record generation module 416 can be configured to generate medical records for storage in the first database 412. The first record generation module 416 can generate a new medical record, insert the data into the new medical record, can assign an identification value (ID) to the new medical record, and can assign a counter value to the new medical record. Furthermore, the first record generation module 416 can assign a counter value to a previously stored medical record when the previously stored medical record is modified or deleted. As will be described further below, the counter value can be used by the second database synchronization module 434 to determine the last medical record received by the data server 430 from the personal computing device 410.

The counter 418 can be configured to provide a counter value to the first record generation module 416. The counter value is a non-time based value, such that the counter value is not based on a time of the day. As should be appreciated, a personal computing device 410 may allow a user to change the time of the day. For example, the time of day may be changed due to daylight savings time or moving across time zones. Thus, to avoid a situation where the user changes the time at the personal computing device 410, thereby possibly creating confusion between the personal computing device 410 and the data server 430, the counter 418 can be implemented as a non-time based counter.

In some embodiments the counter 418 may increment the counter value each time a counter value is provided to the first record generation module 416. In these embodiments, each medical record can have a locally unique counter value associated thereto. For example, the first medical record stored in the first database 412 may be assigned a counter value of 1, the second medical record may be assigned a counter value of 2, and the nth medical record may be assigned a counter value of n. Furthermore, when a medical record is modified or deleted the modified or deleted medical record is assigned a counter value corresponding to the current counter value. For example, if the current counter value is m, and a previously stored medical record having a counter value less than m is modified, the new counter value of the previously stored medical record is reassigned the counter value m.

In some embodiments, the counter value is incremented at each instance of a particular event. A particular event can be any type of event. For instance, an event may be a database synchronization. In these embodiments, the counter value may represent a batch of medical records. Each time the first database 412 is synchronized, the counter 418 can increment the counter value. For example, if four medical records are added, modified, or deleted, prior to a synchronization, the four medical records can each have the same counter value. After the synchronization, the counter 418 can increment the counter value such that medical records added, modified, or deleted after the synchronization and prior to a next synchronization can have the incremented value.

The second database 432 stores a second plurality of medical records. Similar to the first database 432, the second database 432 may receive medical records from one or more sources. For example, the second database 432 may receive medical records from the second record generation module 436. Furthermore, the second database 432 can obtain medical records from the first database 412 by way of a database synchronization. Once stored in the second database 432, medical records can be modified and deleted.

The second record generation module 436 can be configured to generate medical records for storage in the second database 432. The second record generation module 436 can generate a new medical record, insert the data into the new medical record, can assign an identification value (ID) to the new medical record, and can assign a timestamp to the new medical record. Furthermore, the second record generation module 436 can assign a timestamp to a previously stored medical record when the previously stored medical record is modified or deleted at the data server 430. As will be described further below, the timestamp can be used by the first database synchronization module 414 to determine the last medical record received by the personal computing device 410 from the data server 430.

The timestamp generation module 438 may include a clock or similar component that maintains a constant time. It is appreciated that the time can be a standard time that is not changed, e.g. GMT. Each time the second record generation module 436 creates, modifies, or deletes a medical record in the second database 432, the second record generation module 436 can obtain a timestamp and assign the timestamp to the medical record.

A database synchronization can occur at the request of the personal computing device 410 and/or the data server 430. Further, the personal computing device 410 and/or the data server 430 may receive an explicit command to synchronize databases from, for example, a user. Before database synchronization is performed, the personal computing device 410 and the data server 430 are paired. It is appreciated that the pairing can be performed in any suitable manner. For instance, if the personal computing device 410 is requesting that synchronization, the personal computing device 410 may transmit a request to the data server 430 to establish a secure communication path between the two devices 410 and 430. Similarly, the data server 430 can request to establish a secure communication path between the two device 410 and 430.

Once paired, either the first database synchronization module 414 or the second database synchronization module 414 can request to synchronize the first database 412 with the second database 432. Synchronization can be one-way or two-way. For example, one-way synchronization can be when the second database 432 is updated to reflect any changes to the first database 412 but the first database 412 is not updated to reflect any changes in the second database 432, or when the first database 412 is updated to reflect any changes to the second database 432 but the second database 432 is not updated to reflect any changes in the first database 412. Two-way synchronization can be when the second database 432 is updated to reflect any changes to the first database 412 and the first database 412 is updated to reflect any changes in the second database 432.

The first database synchronization module 414 can maintain a last timestamp indicative of a last medical record that was most recently received by the personal computing device 410 from the data server 430. The first database synchronization module 414 can transmit the last timestamp to the second database synchronization module 434 via the secure communication path established when the devices were paired. In some embodiments, the first database synchronization module 414 can provide the last timestamp in a request to synchronize that is provided to the second database synchronization module 434. The second database synchronization module 434 receives the last timestamp and retrieves all medical records from the second database 432 having a timestamp that is greater than the last timestamp. The retrieved medical records are transmitted to the first database synchronization module 414. It is appreciated that the retrieved medical records can be transmitted via the established secure communication path.

The first database synchronization module 414 can receive the transmitted medical records and update the first database 412 with the medical records. For each medical record, the first database synchronization module 414 can determine whether the received medical record is new or a modification of a previously stored medical record. If a medical record is new the first database synchronization module 414 can create a new medical record in the first database 412. The new medical record can include an external identifier (external ID) indicating that the new medical record was originally created on the data server 430. If a medical record is a modified medical record, the first database synchronization module 414 can write over the previous version of the medical record with the modified medical record that was received during synchronization. After receiving the medical records from the second database synchronization module 434, the first database synchronization module 414 can determine the most recent timestamp, i.e., the timestamp having the highest value, and can store the most recent timestamp as the last timestamp. The first database synchronization module 414 can utilize the new last timestamp in a subsequent database synchronization.

The second database synchronization module 434 can maintain a last counter value indicative of a last medical record that was received by the data server 430 from the personal computing device 410. The second database synchronization module 434 can transmit the last counter value to the first database synchronization module 414 via the secure communication path established when the devices were paired. In some embodiments, the second database synchronization module 434 can provide the last counter value in a request to synchronize that is provided to the first database synchronization module 414 or can be provided to the first database synchronization module 414 in response to a request to synchronize received therefrom. The first database synchronization module 414 receives the last counter value and retrieves all medical records from the first database 412 having a counter value that is greater than the last counter value. The retrieved medical records are transmitted to the second database synchronization module 434. As discussed above, the retrieved medical records can be transmitted via the established secure communication path.

The second database synchronization module 434 can receive the medical records from the first database synchronization module 414 and update the second database 432 with the received medical records. For each medical record, the second database synchronization module 434 can determine whether the received medical record is new or a modification of a previously stored medical record. If a medical record is new the second database synchronization module 434 can create a new medical record in the second database 432. The new medical record can include an external identifier (external ID) indicating that the new medical record was originally created on the personal computing device 410. If a medical record is a modified medical record, the second database synchronization module 434 can write over the previous version of the medical record with the modified medical record that was received during synchronization. After receiving the medical records from the first database synchronization module 414, the second database synchronization module 434 can determine the greatest counter value of the received medical records, i.e., the counter value having the highest value, and can store the greatest counter value as the last counter value. The second database synchronization module 434 can utilize the new last counter value in a subsequent database synchronization.

While the foregoing example is directed to a personal computing device 410 and a data server 430, it is appreciated that the foregoing framework can be implemented in other devices as well. For example, the foregoing framework may be applied when synchronizing the diabetes management device 104 to the personal computing device 410, or when the diabetes management device 104 synchronizes with the insulin pump 202. Furthermore, the foregoing is provided for example only and not intended to be limiting. Variations of the techniques described above are contemplated and within the scope of the disclosure.

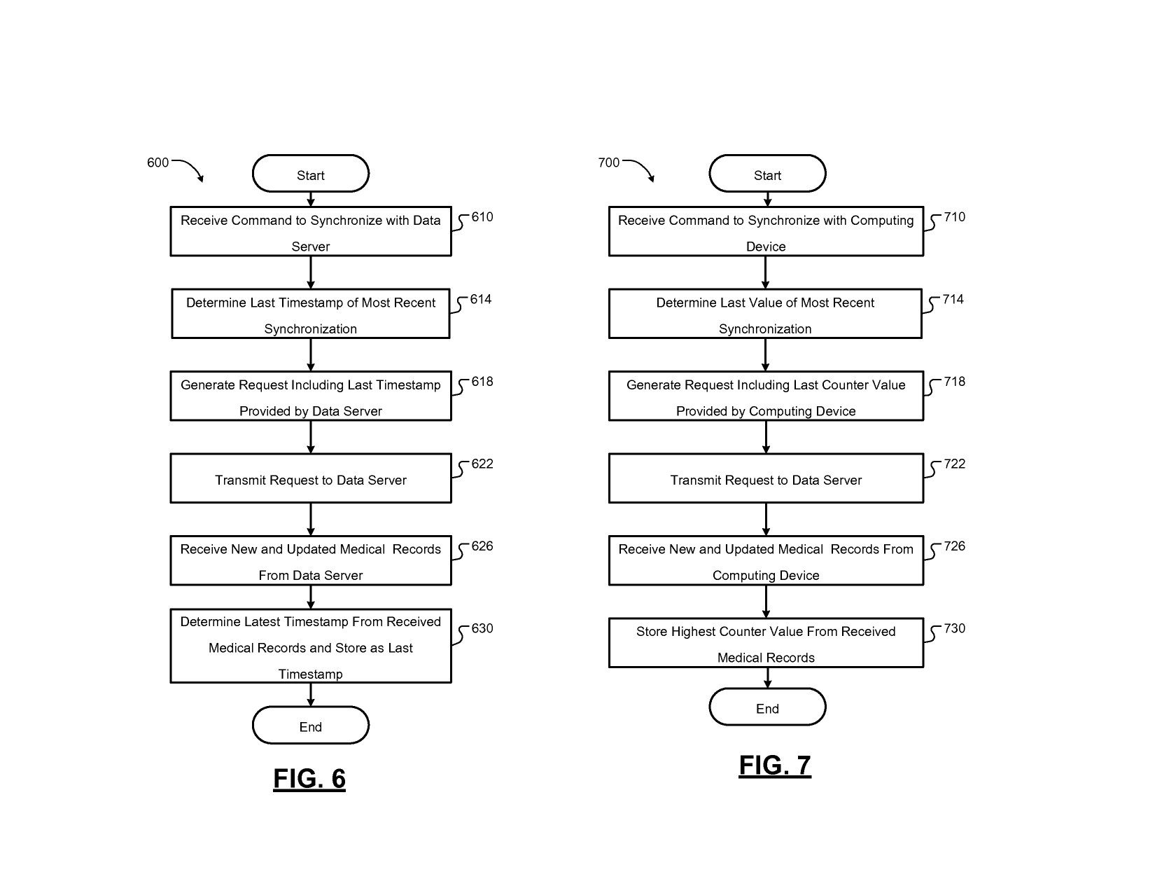

FIG. 6 illustrates a method 600 that may be executed by the first database synchronization module 414. A database synchronization may be initiated by a triggering event such as an explicit instruction by a user or upon the personal computing device 410 pairing with the data server 430. In response to a triggering event, a command can be provided to the first database synchronization module 414, which can be received by the first database synchronization module 414, as shown at step 610. In response to receiving the command to synchronize, the first database synchronization module 414 determines the last timestamp corresponding to the most recent database synchronization, as shown at step 614. As previously discussed, the last timestamp corresponds to the last medical record that was added to or modified on the second database 432 prior to the most recent database synchronization. The first database synchronization module 414 can generate a request to synchronize which can include the last timestamp, as shown at step 618. The first database synchronization module 414 transmits the request to the data server 430, as shown at step 622.

As will be discussed in greater detail below, the second database synchronization module 434 receives the request and provides all of the medical records added to or modified on the second database 432 since the most recent database synchronization to the personal computing device 310. Thus, as shown at step 626, the first database synchronization module 414 receives the new and updated medical records from the data server 430. It is appreciated that if a medical record has been deleted from the second database 432, an indication that the medical record has been deleted may also be provided to the first database synchronization module 414. The first database synchronization module 414 can then store the received medical records, e.g., new medical records and updated medical records, in the first datastore 412. As discussed above, new medical records can be added to the first database 412 and updated medical records can be written over previous versions of the respective updated medical records. Deleted medical records can be purged from the first database 412. Upon receiving the medical records, the first database synchronization module 414 can determine the medical record having the most recent timestamp, e.g., the latest timestamp, as shown at step 630. The first database synchronization module 414 can store the most recent timestamp received from the second database synchronization module 434 as the last timestamp for use in a subsequent database synchronization.

It is appreciated that the foregoing method 600 is provided for example only and not intended to limit the scope of the disclosure. Furthermore, the steps provided can be performed in multiple steps. Variations of the foregoing method 600 are contemplated and are within the scope of the disclosure.

FIG. 7 illustrates a method 700 that may be executed by the second database synchronization module 434. As discussed, a database synchronization may be initiated by a triggering event such as an explicit instruction by a user or upon the personal computing device 410 pairing with the data server 430. In response to a triggering event, the second database synchronization module 434 can receive a command to perform a database synchronization, as shown at step 710. In response to receiving the command to synchronize, the second database synchronization module 434 determines the last counter value corresponding to the most recent database synchronization, as shown at step 714. As discussed above, the last counter value corresponds to the last medical record that was added to or modified on the first database 412 prior to the most recent database synchronization. The second database synchronization module 434 can generate a request to synchronize the databases 412 and 432 which includes the last counter value, as shown at step 718. The second database synchronization module 434 transmits the request to the personal computing device 410, as shown at step 722.

As will be discussed below, the first database synchronization module 414 receives the request and provides all of the medical records added to or modified on the first database 412 since the most recent database synchronization with the data server 430. Accordingly, the second database synchronization module 434 receives the new and updated medical records from the personal computing device 410, as shown at step 726. It is appreciated that if a medical record has been deleted in the first database 412, an indication that the medical record has been deleted may also be provided to the second database synchronization module 434. The second database synchronization module 434 can then store the received medical records, e.g., new medical records and updated medical records, in the second datastore 432. As discussed above, new medical records can be added to the second database 432 and updated medical records can be written over previous versions of the respective updated medical records. Deleted medical records can be purged from the second database 432. Upon receiving the medical records, the second database synchronization module 434 can determine the medical record having the highest counter value, as shown at step 730. The second database synchronization module 434 can store the most recent counter value received as the last counter value for use in a subsequent database synchronization.

It is appreciated that the foregoing method 700 is provided for example only and not intended to limit the scope of the disclosure. Furthermore, the steps provided can be performed in multiple steps. Variations of the foregoing method 700 are contemplated and are within the scope of the disclosure.

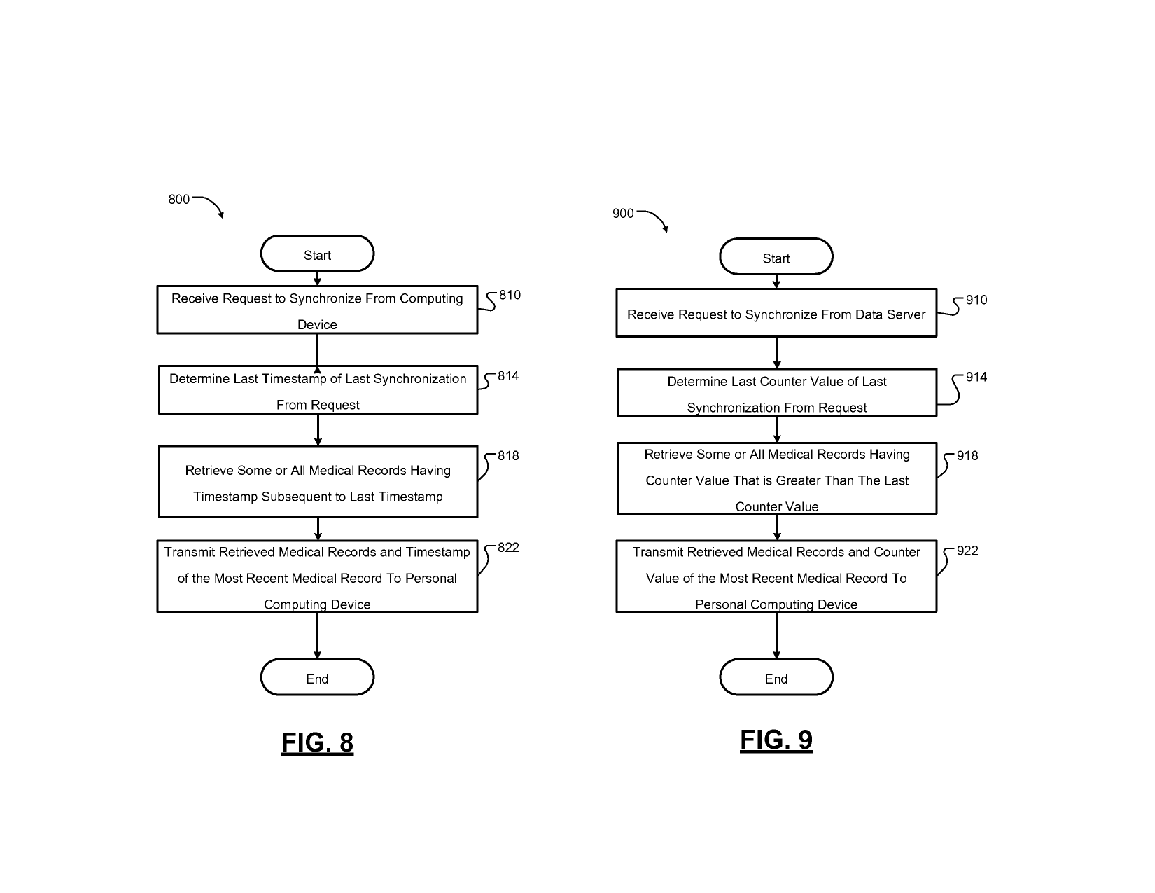

FIG. 8 illustrates an example method 800 that may be executed by the second database synchronization module 434 for responding to a request to synchronize the first database 412 with the second database 432. At step 810, the second database synchronization module 434 receives a request to synchronize databases from the first database synchronization module 414. In some embodiments, the request to synchronize databases may contain the last timestamp corresponding to a previous synchronization. In these embodiments, the second database synchronization module 434 can determine the last time stamp from the request, as shown at step 814. In other embodiments, however, the last time stamp may be received in a transmission that is subsequent to the request. For purposes of this disclosure, however, such subsequent transmissions are considered to be included in the request. Furthermore, if the second database synchronization module 434 is configured to perform two-way synchronization, the second database synchronization module 434 may also provide a request to synchronize the second database 432 with the first database 412 and the last counter value to the first database synchronization module 414 (not shown).

Based on the received last timestamp, the second database synchronization module 434 retrieves medical records having timestamps that are more recent than the last timestamp, as shown at 818. The second database synchronization module 434 can access the second database 432 by querying the second database 432 for some or all medical records having timestamps that are greater than the last timestamp. The second database 432 can retrieve the requested medical records and return the medical records to the second database synchronization module 434. The second database synchronization module 434 can transmit the retrieved medical records to the first database synchronization module 414 via the established communication path, as shown at 822.

It is appreciated that the foregoing method 800 is provided for example only and not intended to limit the scope of the disclosure. Furthermore, the steps provided can be performed in multiple steps. Variations of the foregoing method 800 are contemplated and are within the scope of the disclosure.

FIG. 9 illustrates an example method 900 that may be executed by the first database synchronization module 414 for responding to a request to synchronize the second database 432 with the first database 412. At step 910, the first database synchronization module 414 receives a request to synchronize databases from the second database synchronization module 434. In some embodiments, the request to synchronize databases may contain a last counter value corresponding to a previous synchronization. In these embodiments, the first database synchronization module 414 can determine the last counter value from the request, as shown at step 914. As described above, in other embodiments, the last counter value may be received in a transmission that is subsequent to the request. For purposes of this disclosure, however, such subsequent transmissions are considered to be included in the request. Furthermore, if the first database synchronization module 414 is configured to perform two-way synchronization, the first database synchronization module 414 may also provide a request to synchronize as well as the last timestamp to the second database synchronization module 434 (not shown).

Based on the received last counter value, the first database synchronization module 414 retrieves medical records having a counter value that is more recent than the last counter value, as shown at 918. That is, the first database synchronization module 414 can retrieve any medical records that were added to or modified on the first database 412 subsequent to the most recent database synchronization. The first database synchronization module 414 can access the first database 412 by querying the first database 412 for some or all medical records having counter values that are greater than the last counter value. The first database 412 can return the retrieve such medical records and return the medical records to the first database synchronization module 414. The first database synchronization module 414 can transmit the retrieved medical records to the second database synchronization module 434 via the established communication path, as shown at 922.

It is appreciated that the foregoing method 900 is provided for example only and not intended to limit the scope of the disclosure. Furthermore, the steps provided can be performed in multiple steps. Variations of the foregoing method 900 are contemplated and are within the scope of the disclosure.

As discussed above, the first record generation module 416 and the second record generation module 436 can be configured to generate a new medical record, insert the data into the new medical record, can assign an identification value (ID) to the new medical record, and can assign a timestamp to the new medical record. In some embodiments, the first record generation module 416 and/or the second record generation module 436 can generate identification values that are unique to the medical record across multiple devices. For purposes of explanation, the generation of an ID will be described as being performed by the first record generation module 416.

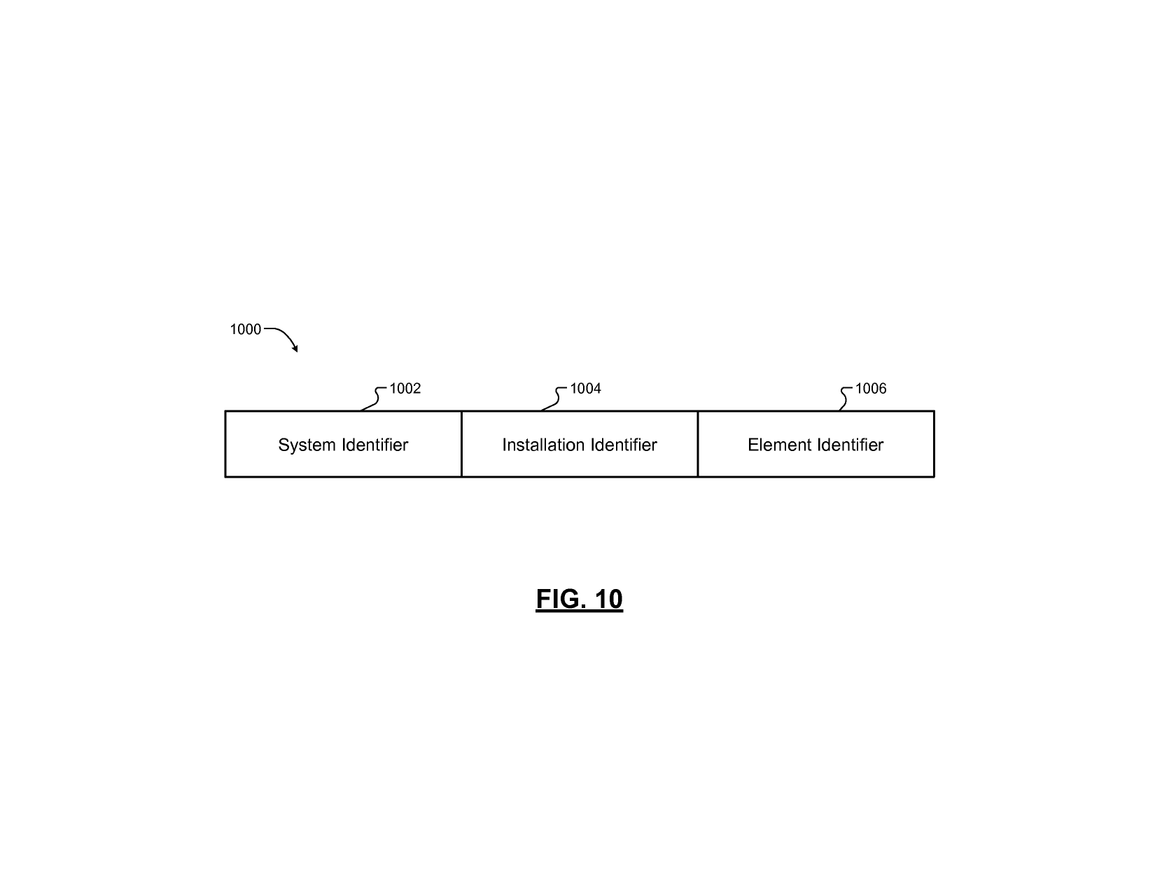

It should be appreciated that the techniques disclosed are applicable to the second record generation module 436 as well. FIG. 10 illustrates an example of an ID 1000 that may be assigned to a medical record. The ID 1000 may include a system type identifier 1002, an installation identifier 1004, and a record identifier 1006.

The system type identifier 1002 can reference a type of system on which the medical record was created. In some embodiments, each type of system may be assigned a unique system value. For instance, a first system value may be assigned a medical record if the medical record is created on the personal computing device 410 (FIGS. 4 and 5), a second system value may be assigned if the medical record is created on a data server 430 (FIGS. 4 and 5), and a third system value may be assigned to the medical record if the medical record is created on a third device, e.g., diabetes management device 104 (FIG. 3). The selection of the specific system values can be arbitrary and the values can be letters, numbers, symbols or combinations thereof.

The installation identifier 1004 can reference an installation instance or other identifier that is unique to the particular system on which the record was created. In some embodiments, different installations on the same type of system may each be assigned a unique installation value. For example, if three personal computing devices 430 are executing the same software, each installation of the software may be assigned a unique installation value. For instance, a first installation value may be assigned to a medical record if the medical record was created on a first personal computing device 430 executing a first installation of software, a second installation value may be assigned to a medical record if the medical record was created on a second personal computing device 430 executing a second installation of software, and a third installation value may be assigned to a medical record if the medical record was created on a third personal computing device 430 executing a third installation of software. It should be appreciated that when a software instance is installed on a device, the software may connect to a central server (not shown) to register the software instance. The central server may be configured to assign a unique installation identifier to each instance upon registering the installation on the device. This unique installation identifier may be assigned to each medical record created on the corresponding device. The assignment of the unique installation identifier can be performed in any suitable manner, and the values can be letters, numbers, symbols or combinations thereof. Alternatively, a serial number unique to the device, such as a MAC address or a serial number can be used as the installation value.

The record identifier 1006 can uniquely identify a record on the device on which the record was created. For example, the first record generation module 414 can assign a unique record identifier 1006 to each record created on the personal computing device. It is appreciated that selection of the specific value of the record identifier 1006 can be selected in any suitable manner and the values can be letters, numbers, symbols or combinations thereof.

As can be appreciated from the foregoing, when the first record generation module 416 creates a new medical record, the first record generation module 416 can create a unique ID based on the system type value of the computing device 410, the installation value of the computing device, and a unique identifier generated by the first record generation module 416. It should be also appreciated that the second record generation module 436 can generate unique IDs in a similar manner.

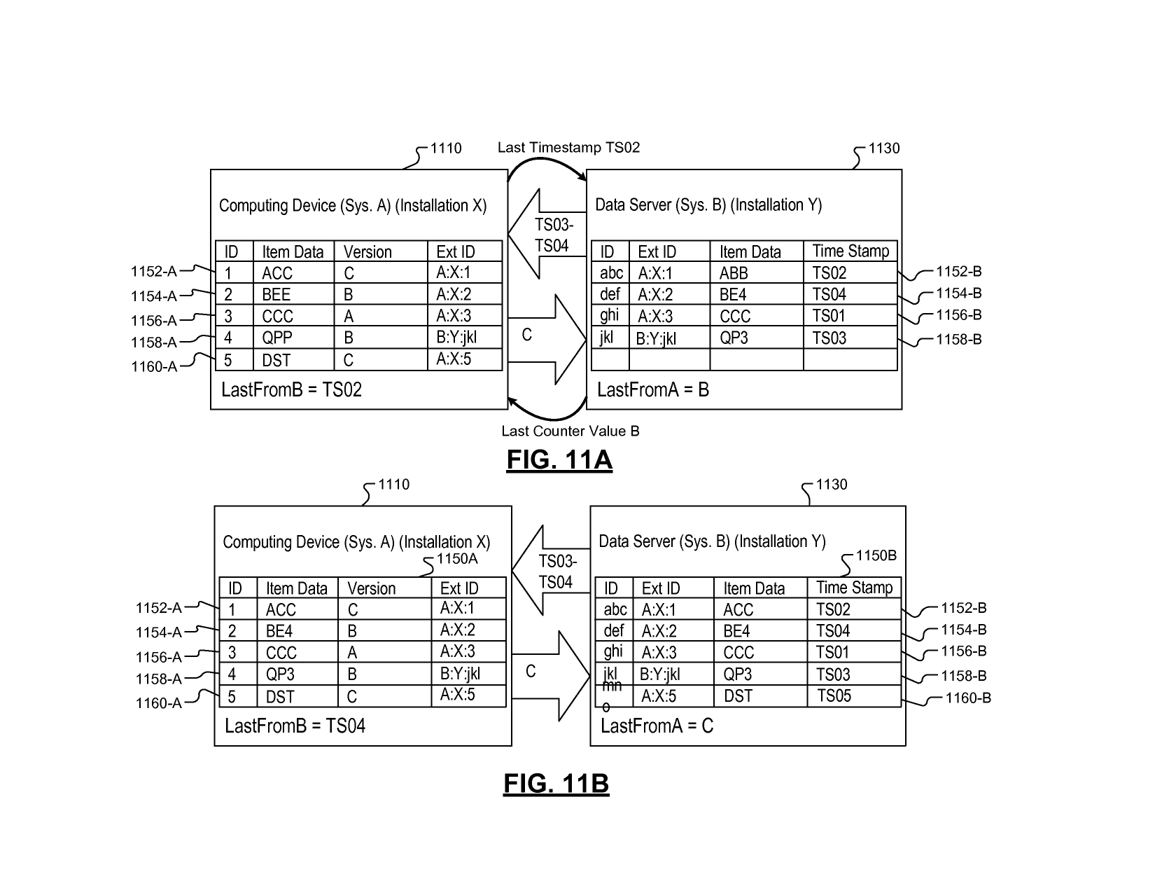

Referring now to FIGS. 11A and 11B, an example of a two-way synchronization is provided. FIG. 11A illustrates a personal computing device 1110 prior to synchronizing with a data server 1130. In the example, a previous synchronization was performed. In the prior synchronization, the last timestamp of a medical record that was provided to the computing device was TS02 and the last counter value of a medical record that was provided to the data server 1130 was B. In the example, each row of tables 1150A and 1150B represents a medical record that is stored in a respective database. The medical records of table 1150A correspond to the medical records of table 1150B according to each medical records respective row. For instance, medical record 1152-A corresponds to medical record 1152-B and medical record 1154-A corresponds to medical record 1154-B. As should be appreciated from the example, since the most recent database synchronization, on computing device 1110 the data of medical record 1152-A has been modified to ACC on the and the medical record 1160-A has been added. Similarly, on the data server 1130, the data of medical record 1154-B has been modified to BE4 and the data of medical record 1158-B has been modified to QP3.

At the time of the synchronization, the personal computing device 1110 can provide the last timestamp TS02 to the data server 1130 and the data server 1130 can provide the last counter value B to the personal computing device 1110. In response to the receiving the last timestamp value, the data server 1130 can transmit all medical records having a timestamp that is subsequent to TS02, e.g., medical records 1154-B and 1158-B, to the personal computing device 1110. Similarly, the personal computing device 1110 can transmit all records having a counter value (version) that are greater than B, e.g., medical records 1152-A and 1160-A, to the data server 1130.

In the example of FIG. 11B, the computing device 1110 and the data server 1130 have synchronized databases. As can be appreciated from the illustrated example, the data in the corresponding medical records match. Further, the last timestamp has been updated to TS04 and the last counter value has been updated to C. It is appreciated that the example of FIGS. 11A and 11B is provided for example only and not intended to limit the scope of the disclosure.

As used herein, the term module may refer to, be part of, or include an Application Specific Integrated Circuit (ASIC); an electronic circuit; a combinational logic circuit; a field programmable gate array (FPGA); a processor (shared, dedicated, or group) that executes code; other suitable components that provide the described functionality; or a combination of some or all of the above, such as in a system-on-chip. The term module may include memory (shared, dedicated, or group) that stores code executed by the processor.

The term code, as used above, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The apparatuses and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

What is claimed is:

1. A data synchronization system for synchronizing medical records between a first device and a second device, the system comprising:
a first database at the first device that stores a plurality of first medical records, each first medical record having a counter value associated thereto, the counter value being indicative of when a first database operation was performed thereon in relation to when other first database operations were performed on other first medical records of the plurality of first medical records;
a second database at the second device that stores a plurality of second medical records, each second medical record having a timestamp associated thereto, the timestamp being indicative of a time when a second database operation was performed on the second medical record;
a first database synchronization module associated with the first device that maintains a last timestamp indicative of a last second medical record of the plurality of second medical records that was most recently received by the first device from the second device, and that transmits, to the second device, a first request for synchronization of the first database with the second database and the last timestamp; and
a second database synchronization module associated with the second device that maintains a last counter value indicative of a last first medical record of the plurality of first medical records that was most recently received by the second device from the first device, and that transmits, to the first device, a second request for synchronization of the second database with the first database and the last counter value.

2. The system of claim 1, further comprising a counter corresponding to the first device that maintains a current counter value that is non-time based, wherein the current counter value at a time at which a specific first database operation is performed on a specific first medical record is associated to the specific first medical record.

3. The system of claim 2, wherein the current counter value is only incremented when a first database operation is performed on one of the plurality of first medical records.

4. The system of claim 2, wherein the current counter value corresponds to a batch of one or more first medical records of the plurality of first medical records, and each instance where the current counter value is incremented is indicative of a different batch of first medical records having first database operations performed thereon.

5. The system of claim 1, further comprising a timestamp generation module corresponding to the second device that maintains a current time and generates a new timestamp each time a second database operation is performed on one of the plurality of second medical records, wherein the new timestamp is associated to the one second medical record on which the second database operation is performed.

6. The system of claim 1, wherein the first database operations include creating a new first medical record in the first database and modifying a previous first medical record stored in the first database, and the second database operations include creating a new second medical record in the second database and modifying a previous second medical record stored in the second database.

7. The system of claim 1, wherein the first device is a personal computing device associated with one of a patient and or a physician of the patient and the second device is a data server that stores medical records.

8. The system of claim 1, wherein the first database synchronization module receives the second request to synchronize and the last counter value from the second database synchronization module, the first database synchronization module retrieves any first medical records of the first plurality of medical records having counter values that are greater than the last counter value from the first database and transmits the retrieved first medical records to the second device.

9. The system of claim 1, wherein when the second database synchronization module receives the first request to synchronize and the last timestamp from the first database synchronization module, the second database synchronization module retrieves any second medical records of the second plurality of medical records having timestamps that are greater than the last timestamp from the second database and transmits the retrieved second medical records to the first device.

10. The system of claim 1, wherein each of the first medical records stored in the first database and the second medical records are each referenced by a unique identifier, the unique identifier including a system identifier component that identifies a system on which the medical record was created, an installation component that identifies a software installation corresponding to the system on which the record was created, and a record identifier that uniquely identifies the medical record in relation to other medical records created on the system.

11. A data synchronization method for synchronizing medical records between a first device and a second device, the method comprising:
storing, at the first device, a plurality of first medical records on a first database, each first medical record having a counter value associated thereto, the counter value being indicative of when a first database operation was performed thereon in relation to when other first database operations were performed on other first medical records of the plurality of first medical records;
storing, at the second device, a plurality of second medical records on a second database, each second medical record having a timestamp associated thereto, the timestamp being indicative of a time when a second database operation was performed the second medical record;
maintaining, at the first device, a last timestamp indicative of a last second medical record of the plurality of second medical records that was most recently received by the first device from the second device;
transmitting, from the first device to the second device, a first request for synchronization of the first database with the second database and the last timestamp;
maintaining, at the second device, a last counter value indicative of a last first medical record of the plurality of first data records which was most recently received by the second device from the first device; and
transmitting, from the second device to the first device, a second request for synchronization of the second database with the first database and the last counter value.

12. The method of claim 11, further comprising maintaining, at the first device, a current counter value that is non-time based, wherein the current counter value at a time at which a specific first database operation is performed on a specific first medical record is associated to the specific first medical record.

13. The method of claim 12, further comprising incrementing the current counter value only when a first database operation is performed on one of the plurality of first medical records.

14. The method of claim 12, wherein the current counter value corresponds to a batch of one or more first medical records of the plurality of first medical records, and each instance where the current counter value is incremented is indicative of a different batch of first medical records having first database operations performed thereon.

15. The method of claim 11, further comprising:
maintaining, at the second device, a current time;
generating, at the second device, a new timestamp each time a second database operation is performed on one of the plurality of second medical records; and
associating the new timestamp to the one second medical record on which the second database operation is performed.

16. The method of claim 11, wherein the first database operations include creating a new first medical record in the first database and modifying a previous first medical record stored in the first database, and the second database operations include creating a new second medical record in the second database and modifying a previous second medical record stored in the second database.

17. The method of claim 11, wherein the first device is a personal computing device associated with one of a patient and or a physician of the patient and the second device is a data server that stores medical records.

18. The method of claim 11, further comprising:
receiving, at the first device, the second request to synchronize and the last counter value from the second device;
retrieving, at the first device, any first medical records of the first plurality of medical records having counter values that are greater than the last counter value from the first database; and
transmitting the retrieved first medical records to the second device.

19. The method of claim 11, further comprising:
receiving, at the second device, the first request to synchronize and the last timestamp from the first device;
retrieving, at the second device, any second medical records of the second plurality of medical records having timestamps that are greater than the last timestamp from the second database; and
transmitting the retrieved second medical records to the first device.

20. The method of claim 11, wherein each of the first medical records stored in the first database and the second medical records are each referenced by a unique identifier, the unique identifier including a system identifier component that identifies a system on which the medical record was created, an installation component that identifies a software installation corresponding to the system on which the record was created, and a record identifier that uniquely identifies the medical record in relation to other medical records created on the system.
